(19) United States
(12) Patent Application Publication
(10) Pub. No.: US 2016/0149428 A1
(43) Pub. Date: May 26, 2016

(54) ELECTRONIC APPARATUS

(71) Applicant: KABUSHIKI KAISHA TOSHIBA, Tokyo (JP)

(72) Inventor: Tsukasa Nunami, Ome Tokyo (JP)

(21) Appl. No.: 14/920,693

(22) Filed: Oct. 22, 2015

Related U.S. Application Data
(60) Provisional application No. 62/082,792, filed on Nov. 21, 2014.

(51) Int. Cl. H02J 7/00; G06F 1/16

(52) U.S. Cl. CPC H02J 7/0047; H02J 7/007; G06F 1/1669; G06F 1/1635; H02J 2007/005

(57) ABSTRACT

According to one embodiment, an electronic apparatus removably connectable to an external apparatus includes a first battery and circuitry. The circuitry sets a charge mode of the first battery to a first or second mode, sets, when the external apparatus includes a second battery, a charge mode of the second battery to the first or second mode, and displays a combination of charge mode options of the first mode and the second mode for the first battery and charge mode options of the first mode and the second mode for the second battery, and usage information suitable for the combination.

### CROSS-REFERENCE TO RELATED APPLICATIONS

This application claims the benefit of U.S. Provisional Application No. 62/082,792, filed Nov. 21, 2014, the entire contents of which are incorporated herein by reference.

### FIELD

Embodiments described herein relate generally to an electronic apparatus removably connected to an external apparatus.

### BACKGROUND

Recently, there have been electronic apparatuses that can be used on their own and can be used by being connected to an external apparatus. One of the examples is a tablet computer (hereinafter referred to as tablet). A tablet includes a touch panel but not an input device such as keyboard or mouse. By the touch operation of the touch panel, a user can run various applications and select various buttons of the interface screen of the applications. Further, the user can input characters by displaying a software keyboard on the screen and touching its keys. However, because some users prefer to input characters with a hardware keyboard, a keyboard dock is sold separately. When connected to the keyboard dock, the tablet becomes like a PC with being opened and can be used as such. The tablet and keyboard dock are equipped with a rechargeable battery and can be used as a mobile device where AC power is unavailable. While the tablet requires a battery as being used on its own, some keyboard docks are not equipped with a battery. A keyboard dock that is not equipped with a battery is driven by a battery equipped in a tablet when the tablet is connected. The battery is charged when the tablet and keyboard dock are driven by AC power.

In contrast, there is a concern regarding the battery that its function will deteriorate prematurely and its lifetime is shortened if a battery charge completion state (full-charge state) is maintained for a long time when the capacity at the time of battery charge completion (at the time of full charge) is around a rating. If a charge state is maintained around a capacity that is smaller than a rated capacity, it is possible to make deterioration in function less likely to occur and make lifetime less likely to be shortened. Therefore, when an AC adaptor is mainly used and the battery hardly used, it is possible to delay the function deterioration of the battery if the capacity at the time of full charge is reduced to smaller than a rating. In order to achieve this, a recent mobile device can switch a charge mode between a normal charge mode (where the capacity at the time of full charge is a rating) and an eco-charge mode where the capacity at the time of full charge is smaller than a rating. Nevertheless, when two apparatuses are each equipped with a battery or only one of them is equipped with a battery, it is not easy to set the charge mode of the respective apparatuses.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary perspective view illustrating a structure of an electronic apparatus of an embodiment.

FIG. 2 is an exemplary block diagram illustrating an electrical configuration of the electronic apparatus of the embodiment.

FIG. 3 is an exemplary flowchart illustrating an operation of a battery manager which is one of the utility programs of the electronic apparatus of the embodiment.

FIG. 4 is an exemplary view illustrating a display screen of the battery manager of the embodiment.

FIG. 5 is another exemplary view illustrating a display screen of the battery manager of the embodiment.

FIG. 6 is still another exemplary view illustrating a display screen of the battery manager of the embodiment.

FIG. 7 is an exemplary view illustrating a display screen of recommending an eco-charge mode of the embodiment.

FIG. 8 is an exemplary view illustrating a display screen of automatically releasing the eco-charge mode of the embodiment.

FIG. 9 is another exemplary flowchart illustrating an operation of the utility programs of the electronic apparatus of the embodiment.

FIG. 10 is a flowchart subsequent to FIG. 9.

### DETAILED DESCRIPTION

Various embodiments will be described hereinafter with reference to the accompanying drawings.

In general, according to one embodiment, an electronic apparatus removably connectable to an external apparatus includes a first battery and circuitry. The circuitry is configured to set a charge mode of the first battery to a first mode or a second mode, wherein a capacity at a charge completion time of the second mode is smaller than a capacity at a charge completion time of the first mode; set, when the external apparatus includes a second battery, a charge mode of the second battery to the first mode or the second mode; and display a combination of charge mode options of the first mode and the second mode for the first battery and charge mode options of the first mode and the second mode for the second battery, and usage information for the electronic apparatus and the external apparatus suitable for the combination.

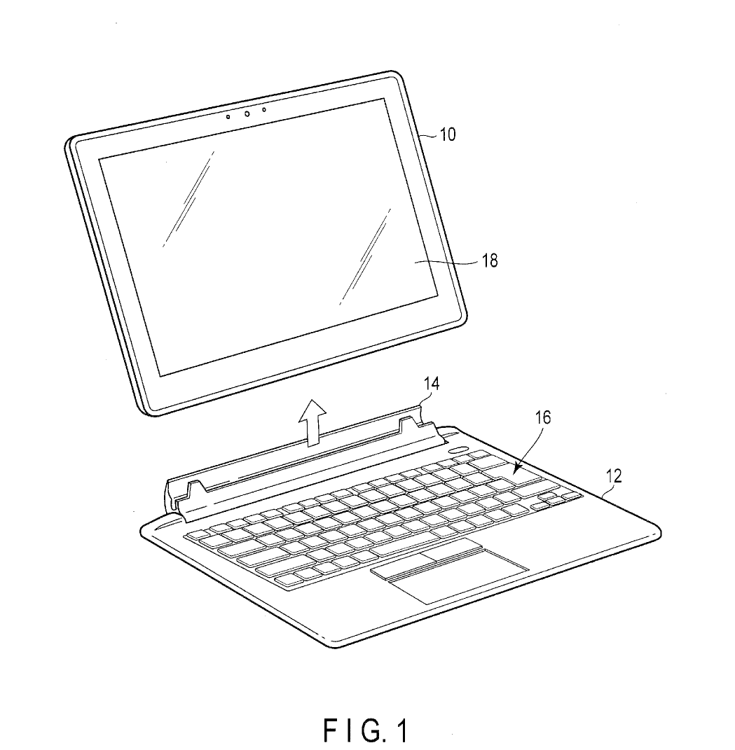

FIG. 1 is an exemplary perspective view illustrating the structure of the electronic apparatus of the embodiment. The electronic apparatus of the embodiment is a tablet 10 which can be operated by touching and is not equipped with a hardware keyboard. The tablet 10 is removably attached to a keyboard dock 12. The tablet 10 includes a touch screen display 18. The keyboard dock 12 includes a keyboard 16 on the surface and a support 14, which fixes the tablet 10, in the back end portion. A docking port is provided in a predetermined position of the lower side surface of the tablet 10 (for example, one point of the middle portion or two points of the left and right end portions). A docking connector is provided in the back end portion of the keyboard dock 12 corresponding to the docking port of the tablet 10 when the tablet 10 is inserted into the support 14. The docking connector has a plug shape including a pin and the docking port has a receptacle shape to which the pin is inserted. Therefore, when the tablet 10 is mounted in the support 14, the docking port and the docking connector are connected to achieve the same state as a state where a notebook PC is open. The support 14 may include a hinge mechanism to enable the tablet 10 to be closed with the tablet 10 inserted into the support 14.

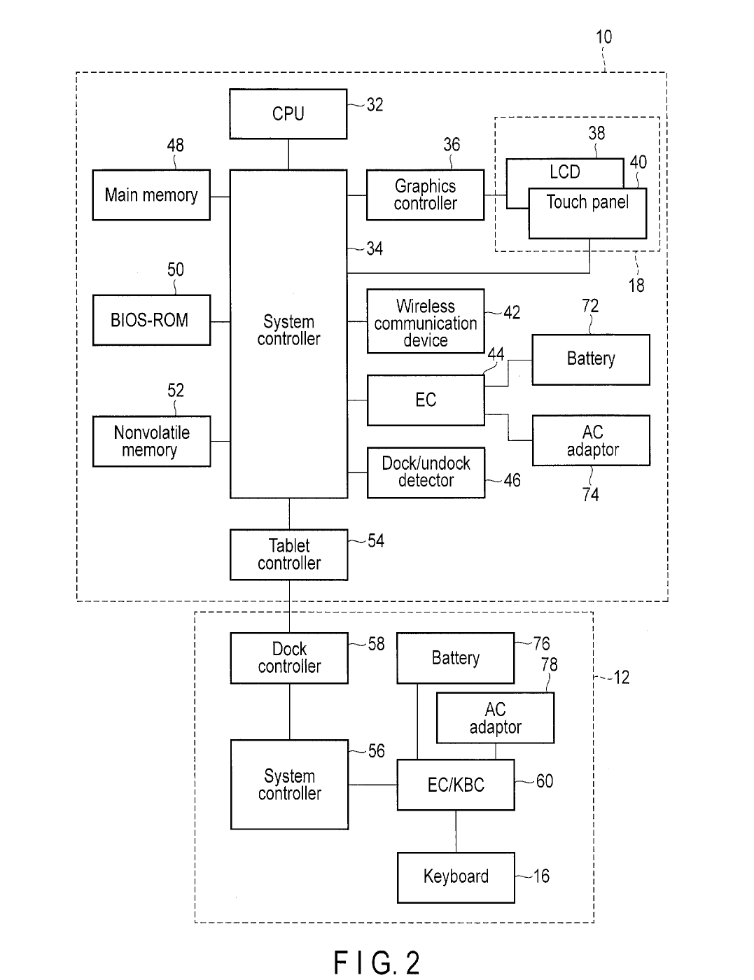

FIG. 2 is a block diagram illustrating an electrical configuration of the tablet 10 and the keyboard dock 12. The tablet 10 includes components such as a CPU 32, a system controller 34, a graphics controller 36, an LCD 38 and a touch panel 40 which constitute the touch screen display 18, a wireless communication device 42, an embedded controller (EC) 44, a dock/undock detector 46, a main memory 48, a BIOS-ROM 50, a nonvolatile memory 52 and a tablet controller 54.

The CPU 32 is a processor circuit that controls the operation of the components in the tablet 10. The CPU 32 executes a variety of software loaded from the nonvolatile memory 52, which is a storage device, to the main memory 48. The software includes an operating system (OS) and application programs and utility programs. The utility programs include a battery manager that sets the charge mode of a battery.

The CPU 32 also executes a basic input/output system (BIOS) stored in the BIOS-ROM 50. The BIOS is a program for controlling hardware.

The system controller 34 is a device that is connected to the components of the CPU 32 such as the graphics controller 36, the wireless communication device 42, the embedded controller 44, the dock/undock detector 46, the main memory 48, the BIOS-ROM 50, the nonvolatile memory 52 and the tablet controller 54 and connects the local bus of the CPU 32 and the components. The system controller 34 is equipped with a memory controller that performs access control for the main memory 48. The system controller 34 has a function to execute communication with the graphics controller 36 via, for example, a serial bus conforming to the PCI EXPRESS standard.

The graphics controller 36 is a display controller that controls the LCD 38 which is used as a display monitor of the tablet 10. A display signal generated by the graphics controller 36 is transmitted to the LCD 38. The LCD 38 displays a screen image based on the display signal. On the LCD 38 is provided the touch panel 40. The touch panel 40 is a capacitance-type pointing device for performing input on the screen of the LCD 38. The contact position on the screen touched by a finger, the movement of the contact position, etc., is detected by the touch panel 40.

The wireless communication controller 42 is a device configured to execute wire communication such as wireless LAN or 3G mobile communication in order to connect to the internet, etc.

The embedded controller 44 is a single-chip microcontroller for power management. A battery 72 and an AC adaptor 74 are connected to the embedded controller 44. The tablet 10 is driven by current from the AC adaptor 74 or the battery 72. The battery 72 is charged by current from the AC adaptor 74 during undocking. The AC adaptor 74 is connected to the tablet 10 via the docking port in the lower end portion of the tablet 10. Therefore, during docking, the AC adaptor 74 cannot be connected to the tablet 10, the tablet 10 is not supplied with current from the AC adaptor 74, and the battery 72 cannot be charged by current from the AC adaptor 74. During docking, the battery 72 equipped in the tablet 10 is charged by current from the keyboard dock 12.

The dock/undock detector 46 detects docking and undocking of the keyboard dock 12 by means of a mechanical switch provided in the docking connector and by means of the level change of a particular signal line connected to the keyboard dock 12. When docking is detected, a docking event is generated. The dock/undock detector 46 can also detect the model of a keyboard dock docking the tablet 10. The model of a keyboard dock includes a model equipped with a battery and a model that is not equipped with a battery.

The tablet controller 54 is a connecting interface of the keyboard dock 12 and is connected to the keyboard dock 12 via the docking port.

The keyboard dock 12 includes a dock controller 58, a system controller 56, an embedded controller/keyboard controller (EC/KBC) 60, the keyboard 16, etc. The battery 76 and the AC adaptor 78 are connected to the embedded controller/keyboard controller 60. The embedded controller/keyboard controller 60 performs power management and keyboard control. The AC adaptor 78 is connected to the keyboard dock 12 via the side surface or the back surface of the keyboard dock 12. In some models, the keyboard dock 12 is not equipped with the battery 76. The keyboard dock 12 is driven by the battery 72 equipped in the tablet 10, when the tablet 10 is docked to the keyboard dock 12 which is not equipped with the battery 76 and the AC adaptor 78 is not connected to the keyboard dock 12.

As shown in FIG. 2, when the tablet 10 is docked to the keyboard dock 12 equipped with the battery 76, the battery 76 may be charged firstly in priority by current from the AC adaptor 78. As shown in FIG. 2, the battery 76 may be used firstly in priority when the tablet 10 is docked to the keyboard dock 12 equipped with the battery 76 and both the batteries 72 and 76 are charged.

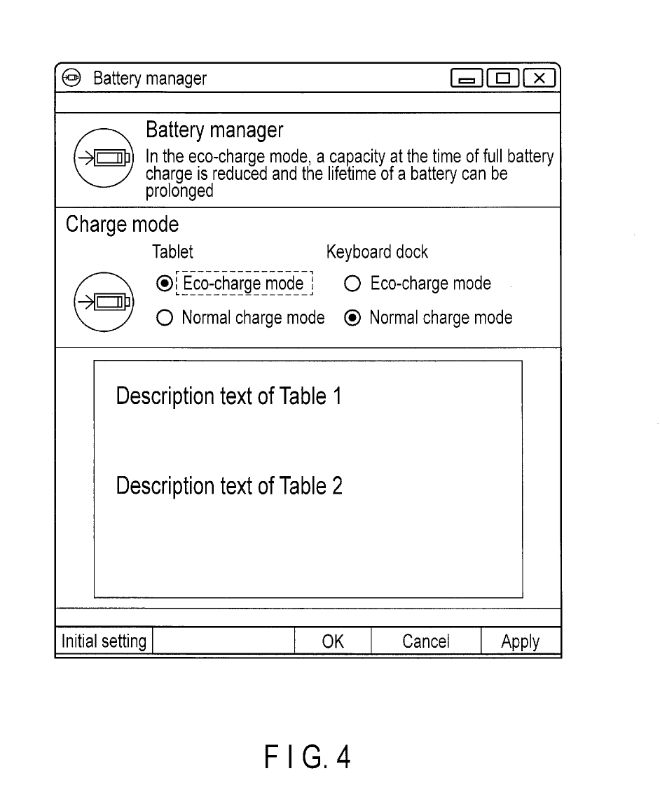

As described above, a capacity at the time of battery charge completion should be reduced to smaller than a rating in order to prolong the lifetime of a battery. Therefore, in the embodiment, the battery manager that can adjust a capacity at the time of battery charge completion is prepared as a utility program of the tablet 10. When the battery manager is activated, the setting screen of a charge mode is displayed as shown in, for example, FIG. 4, 5 or 6. On this screen, it is possible to set the respective charge modes of the battery 72 of the tablet 10 and the battery 76 of the keyboard dock 12 to an eco-charge mode or a normal charge mode. The normal charge mode is a mode of charging to a rated capacity whereas the eco-charge mode is a mode of charging to, for example, approximately 80% of a rated capacity. In the upper portion of the screen is displayed a description of the battery manager, below that are displayed the option of the charge mode of the battery 72 equipped in the tablet 10 and the option of the charge mode of the battery 76 equipped in the keyboard dock 12, and below that are displayed a description of combination of the charge modes set.

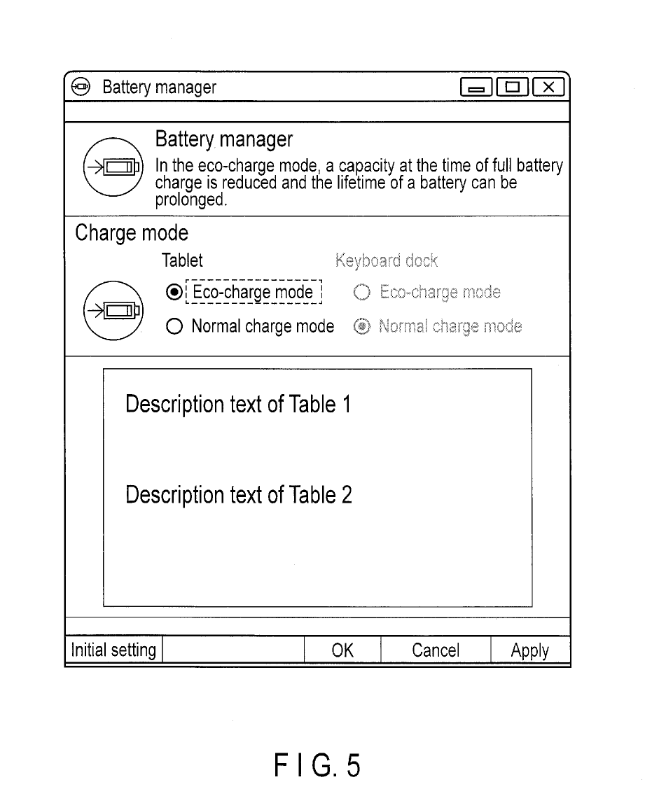

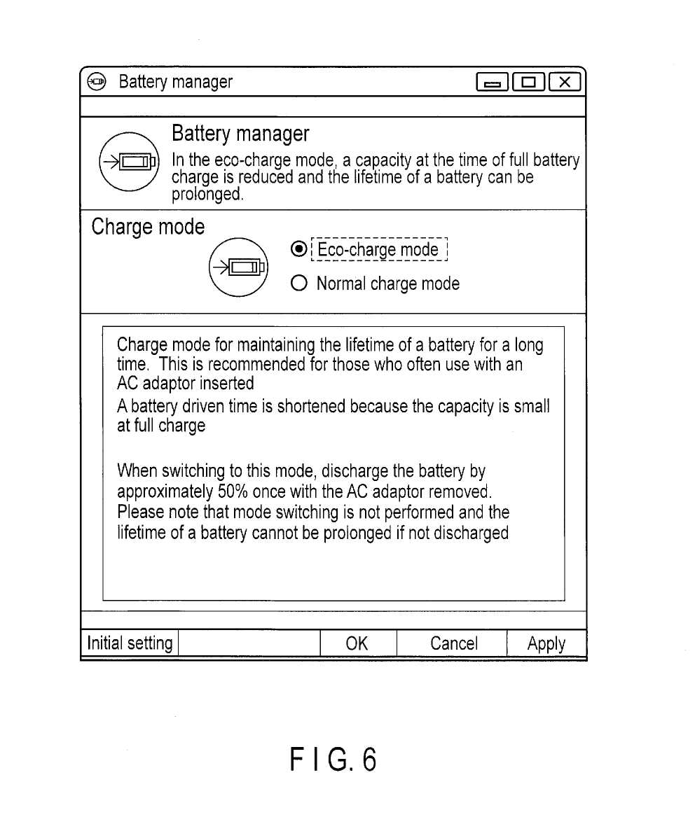

The embodiment is not limited to a use form including two batteries as shown in FIG. 2 but also includes a use form where the keyboard dock 12 does not include the battery 76 and only the tablet 10 includes the battery 72. The use form including only the battery 72 equipped in the tablet 10 includes a case where only the tablet 10 was purchased and the keyboard dock 12 was not purchased, a case where docking is not performed currently though the keyboard dock 12 was purchased, and a case where a keyboard dock which is not equipped with a battery was purchased. FIG. 4 assumes a use form including two batteries. In different use forms, the setting screen shown in FIG. 5 or 6 is displayed.

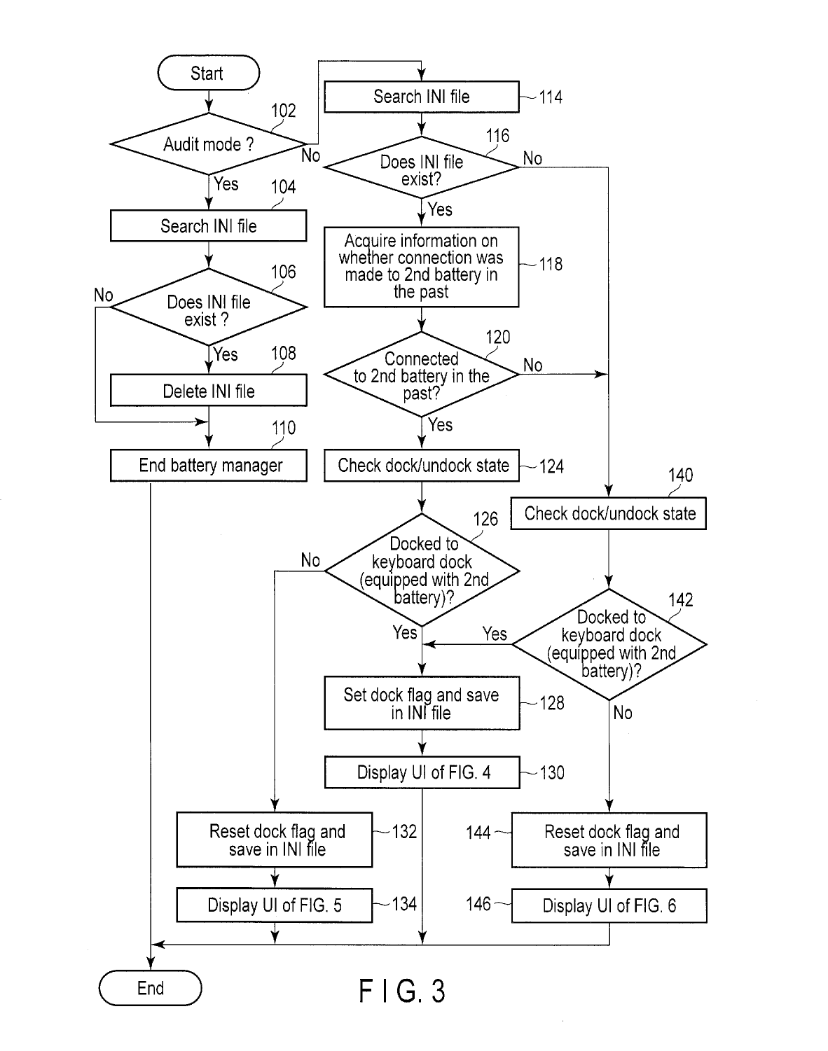

FIG. 3 is a flowchart illustrating the processing of the battery manager, which is a utility program, of setting a charge mode. The utility may be activated, when resumed from suspend, when receiving a docking event, etc.

In block 102, it is determined whether the operation mode of the tablet 10 is an audit mode. The audit mode is a mode that indicates a condition where an OS is being set and is considered as a mode that is used in a production line, etc., and is not actually used by the user. Therefore, in the audit mode, no processing is substantially performed and an INI file that records data on setting is searched in block 104. The INI file records data on whether connection was made to a keyboard dock equipped with a battery in the past and data on the model of the keyboard dock.

In block 106, it is determined whether the INI file exists. If the INI file exists, the INI file is deleted in block 108 because no INI file is required in the audit mode and the battery manager (if activated) is ended in block 110. If no INI file exists, the battery manager is ended in block 110.

If not in the audit mode, an INI file that records a setting is searched in block 114. In block 116, it is determined whether the INI file exists. If the INI file exists, data on whether connection was made to the keyboard dock 12 equipped with the battery 76 in the past even once is read from the INI file in block 118. The battery 72 equipped in the tablet 10 is referred to as the first battery and the battery 76 equipped in the keyboard dock 12 is referred to as the second battery. In block 120, it is determined whether connection was made to the keyboard dock equipped with the battery, i.e., the second battery in the past. If the connection was made, the state of the dock/undock detector 46 is checked in block 124.

In block 126, it is determined whether the tablet 10 is docked to the keyboard dock 12 equipped with the battery 76 (second battery). If docked, a dock flag is set and saved in the INI file in block 128. In this case, since two batteries exist, the user interface (UI) of FIG. 4 which is the setting screen of the two batteries is displayed in block 130. The user interface of the battery manager includes a description text of Table 1 and a description text of Table 2 in accordance with a combination of the charge modes of the tablet and the keyboard dock. This enables the user to understand which combination of charge modes is effective for what kind of state of use while viewing the description and to optimally set the charge mode of the tablet and the keyboard dock.

TABLE 1

Charge mode

| | Keyboard | |
|---|---|---|
| Tablet | dock | Description text |
| Normal | Normal | N/A |
| charge | charge | |
| Eco | Normal | This is recommended for those |
| charge | charge | who often carry with a note |
| | | PC style. The eco-charge mode is |
| | | set only on the tablet side. |
| Normal | Eco | This is recommended for those |
| charge | charge | who often carry the tablet and |
| | | often use the keyboard dock with |
| | | the AC adaptor connected. |
| | | The eco-charge mode is set only |
| | | on the keyboard dock side. |
| Eco | Eco | This is recommended for those |
| charge | charge | who often use in a note PC style |
| | | with the AC adaptor connected. |
| | | The eco-charge mode is set both |
| | | on the tablet side and the |
| | | keyboard dock side. |

TABLE 2

Charge mode

| | Keyboard | |
|---|---|---|
| Tablet | dock | Description text |
| Normal | Normal | This is a general battery |
| charge | charge | charge mode. This is recommended |
| | | for those who want to use for |
| | | a long time as much as possible |
| | | by battery drive. |
| Eco | Normal | The eco-charge mode is a charge |
| charge | charge | mode of maintaining the lifetime of |
| Normal | Eco | a battery for a long time. |
| charge | charge | This is recommended for those |
| Eco | Eco | who often use with the AC adaptor |
| charge | charge | connected. The battery drive |
| | | time is shortened in order to |
| | | reduce a capacity at the time |
| | | of full charge. |
| | | When the setting is made to the |
| | | eco-charge mode, operation is |
| | | performed by battery drive until |
| | | discharge is made at approximately |
| | | 80%. While no charge is made |
| | | during this period even when the AC |
| | | adaptor is connected, charging |
| | | starts if the eco-charge mode is |
| | | made invalid. |

If it is determined in block 126 that the tablet 10 is not docked to the keyboard dock 12 equipped with the battery 76 (second battery), the dock flag is reset and saved in the INI file in block 132. In this case, since connection was made to the keyboard dock equipped with the second battery in the past (it is highly likely that the user owns a keyboard dock equipped with the second battery) though docking is not made currently to the keyboard dock equipped with the second battery, the user interface of FIG. 5 is displayed in block 134 to display at a normal brightness the option of a charge mode of the first battery equipped in the tablet and slightly display at approximately the half brightness the option of a charge mode of the second battery equipped in the keyboard dock. The description text displayed in the UI of FIG. 5 is the same as that of FIG. 4. In this state, the user therefore understands it is better to dock the tablet to the keyboard dock equipped with the second battery depending on a state, although the user does not inadvertently select the charge mode of the second battery equipped in the keyboard dock.

In block 120, if the connection was not made to the keyboard dock equipped with the second battery in the past, the state of the dock/undock detector 46 is checked in block 140.

In block 142, it is determined whether the tablet 10 is docked to the keyboard dock 12 equipped with the second battery 76. If docked, the dock flag is set and saved in the INI file in block 128. In this case, since two batteries exist, the user interface (UI) of FIG. 4 which is the setting screen of the two batteries is displayed in block 130. This enables the user to optimally set the charge modes of the tablet and the keyboard dock while viewing the description.

If it is determined in block 142 that the tablet 10 is not docked to the keyboard dock 12 equipped with the second battery 76, the dock flag is reset and saved in the INI file in block 144. In this case, since connection is/was not made to the keyboard dock 12 equipped with the second battery 76 currently or in the past, it is highly likely that the user does not own a keyboard dock equipped with the second battery. Thus, the user interface of FIG. 6 is displayed in block 146 where the option of a charge mode of the second battery equipped in the keyboard dock is not displayed and only the option of a charge mode of the first battery equipped in the tablet is displayed. The user therefore cannot select the option of the charge mode of the second battery.

Thus, according to the utility program of FIG. 3, the eco-charge mode/normal charge mode can be set independently for the battery equipped in the tablet and the battery equipped in the keyboard dock, respectively. Since the tablet and the keyboard dock are detachable and the keyboard dock has a model equipped with the battery and a model that is not equipped with the battery, various states of use of two apparatuses can occur. For example, while some purchase both together, others purchase only the tablet. According to the processing of FIG. 3, since state of use can be distinguished, it is possible to display an appropriate guidance on the setting screen of a charge mode so that the user can select a charge mode appropriately.

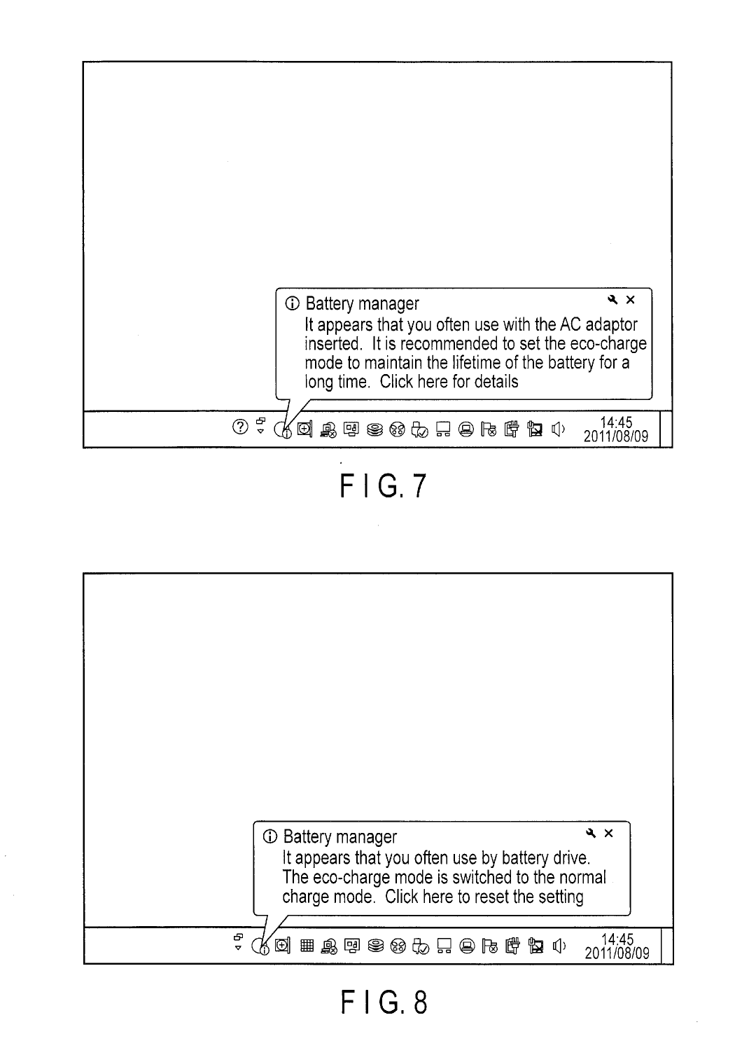

While the battery manager has a function to display the description of a charge mode according to the setting state of a charge mode as shown in FIGS. 4, 5 and 6, the battery manager also has a function to monitor the charge/discharge state of the battery to perform appropriate processing and display a guidance message accordingly. For example, if the charge/discharge state satisfies a certain condition, a message that recommends the eco-charge mode may be displayed (see FIG. 7) or the setting may be made automatically to the eco-charge mode to display its message. Also, if the charge/discharge state satisfies another condition, a message that recommends the normal charge mode may be displayed or the setting may be made automatically to the normal charge mode to display its message (see FIG. 8). In the condition of setting to the eco-charge mode, for example, a battery capacity may continue to be close to full charge for a predetermined time. In this case, since drive is performed by an AC adaptor, it is preferable that the full charge capacity of a battery be made smaller than a rating to prevent the lifetime of the battery from being shortened. In the condition of setting to the normal charge mode, for example, charging from a state where a battery capacity is close to full charge to a state where a battery capacity is close to 0% may be repeated within a predetermined time by a predetermined of times. In this case, since battery drive is performed, it is preferable that the full charge capacity of a battery be a rating to prolong the lifetime of the battery drive time.

A monitoring timer, which records the change in capacity value of a battery as time passes, is provided to detect a charge/discharge state. Since the battery manager is a utility program of the tablet 10, the battery manager cannot monitor the battery of the keyboard dock 12 to which the tablet 10 is not docked. Therefore, in the embodiment, the monitoring timer is provided in the EC 44 of the tablet 10 and the EC/KBC 60 of the keyboard dock 12 to monitor charge/discharge of the battery by the respective embedded controllers of the tablet 10 and the keyboard dock 12. While the battery on the side of the tablet 10 can be monitored by the battery manager and the EC 44 therefore does not need to be provided with the monitoring timer, the monitoring timer is provided in the EC 44 because the processing can be performed more easily together with the keyboard dock 12.

The monitoring timers of the EC/KBC 60 and the EC 44 cannot determine whether battery discharge (battery drive) is performed by means of a device by the user or by means of a device in a factory before shipment. That is, when the battery is used before shipment, the monitoring timers of the EC/KBC 60 and the EC 44 cannot properly monitor the charge/discharge state of the battery. However, the utility program of the tablet 10 can recognize that the user starts to use. Therefore, in the embodiment, the utility program resets the monitoring timers of the EC/KBC 60 and the EC 44 when the user starts using.

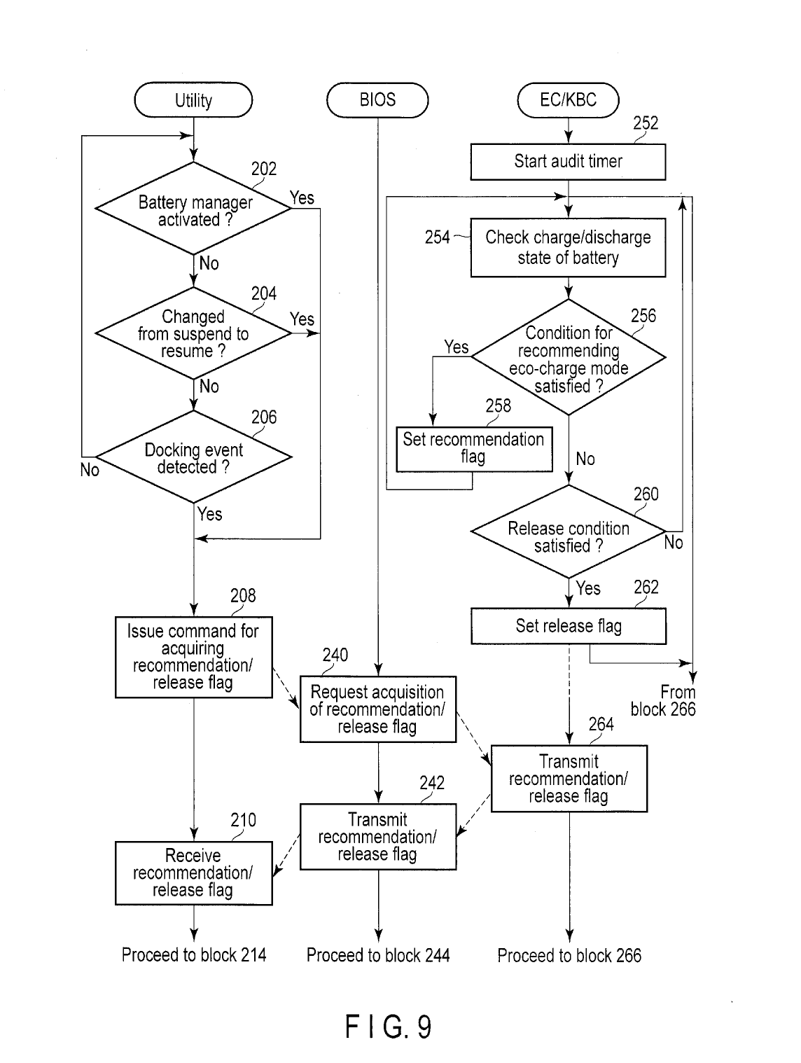

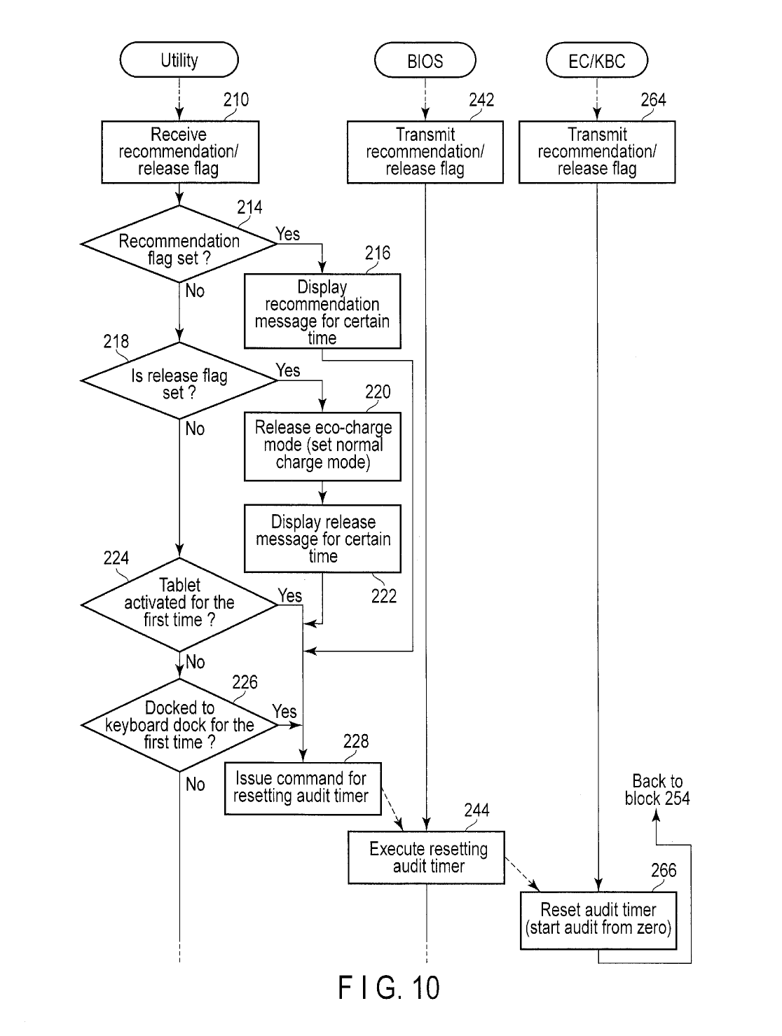

FIGS. 9 and 10 are flowcharts illustrating the processing of a function to reset the monitoring timer of the EC/KBC 60 and to display a message in accordance with the output of the monitoring timer of the EC/KBC 60. The reset of the monitoring timer of the EC 44 is the same as FIGS. 9 and 10 and will therefore not be described.

In block 252, the EC/KBC 60 starts the monitoring timer to measure the capacity of the battery 76 and calculate time change in capacity. The EC/KBC 60 checks the charge/discharge state of the battery 76 in block 254. The EC/KBC 60 determines in block 256 whether the setting recommendation condition of the eco-charge mode is satisfied (for example, not limited thereto though, a state where the capacity of a battery is close to full charge continues for a predetermined time). If satisfied, the EC/KBC 60 sets a recommendation flag in block 258 and returns to block 254 to continue to check the charge/discharge state of the battery 76.

If the setting recommendation condition of the eco-charge mode is not satisfied, the EC/KBC 60 determines in block 260 whether the automatic release condition of the eco-charge mode is satisfied (for example, not limited thereto though, charging from a state where a battery capacity is close to full charge to a state where a battery capacity is close to 0% is repeated within a predetermined time by a predetermined number of times). If satisfied, the EC/KBC 60 sets a release flag in block 260 and returns to block 254 to continue to check the charge/discharge state of the battery 76.

In contrast, the utility program (battery manager) determines in block 202 whether the battery manager is activated. If not activated, the utility program determines in block 204 whether suspend is changed to resume. If not changed, the utility program determines in block 206 whether a docking event is detected. If no docking event is detected, block 202 is executed again.

If the battery manager is activated in block 202, if suspend is changed to resume in block 204, and if a docking event is detected in block 206, the utility issues a command for acquiring the recommendation/release flag and transmits the command to the BIOS (tablet) in block 208. The BIOS requests the EC/KBC 60 to acquire the recommendation/release flag in block 240.

The processing mentioned above so far can be performed independently in the tablet 10 and the keyboard dock 12, respectively. Therefore, even if the tablet 10 is not docked to the keyboard dock 12, the EC/KBC 60 checks the charge/discharge state of the battery 76 and sets the recommendation/release flag once the condition is satisfied.

When the tablet 10 is docked to the keyboard dock 12, the utility performs the processing from block 208 of FIG. 9. Upon receiving the acquisition request of the recommendation/release flag from the BIOS, the EC/KBC 60 transmits the recommendation/release flag to the BIOS in block 264. The BIOS transmits the recommendation/release flag to the utility in block 242.

The utility determines in block 214 whether the recommendation flag is set. If the recommendation flag is set, the utility displays a recommendation message as shown in FIG. 7 in the lower side of the screen for a certain time in block 216 and proceeds to block 228. If any one portion of the recommendation message is clicked, the setting screen (any of FIGS. 4, 5 and 6, depending on a state) of the battery manager is displayed. At this time, a recommendation message such as “It is recommended to make the setting on the tablet side (or keyboard dock side) the eco-charge mode.” is inserted in the middle of the display of the charge mode and the display of description in the UI of FIGS. 4, 5 and 6.

If no recommendation flag is set in block 214, the utility determines in block 218 whether the release flag is set. If the release flag is set, the utility forcibly releases the eco-charge mode to set the normal charge mode in block 220 and the utility displays a release report message as shown in FIG. 8 in the lower side of the screen for a certain time in block 222 and proceeds to block 228. If any one portion of the release report message is clicked, the setting screen (any of FIGS. 4, 5 and 6, depending on a state) of the battery manager is displayed. At this time, a release report message such as “The setting on the tablet side (or keyboard dock side) has been changed to the normal charge mode.” is inserted in the middle of the display of the charge mode and the display of description in the UI of FIGS. 4, 5 and 6.

If no release flag is set in block 218, the utility determines in block 224 whether the tablet is activated for the first time. If this is the first activation (for example, the permission screen of OS is operated), the utility proceeds to block 228. If not the first activation, the utility determines in block 226 whether the tablet is docked to the keyboard dock for the first time. If this is the first docking, the utility proceeds to block 228.

The utility issues a command for resetting the monitoring timer and transmits the command to the BIOS (tablet) in block 228. The BIOS requests the EC/KBC 60 to execute resetting the monitoring timer in block 244. The EC/KBC 60 resets the monitoring timer to discard the previous monitoring values in block 266. Block 254 is executed after block 266 to newly monitor a charge/discharge state from this timing.

By the processing of FIGS. 9 and 10, the utility can acquire the monitoring result of the charge/discharge state by the monitoring timer from the EC/KBC 60, at least at any timing of when the battery manager is activated, when suspend is changed to resume, and when a docking event is acquired. Therefore, even if the tablet 10 is undocked from the keyboard dock 12, it is possible to monitor the charge/discharge state of the battery equipped in the keyboard dock. Further, by the processing of FIGS. 9 and 10, the utility can reset the monitoring timer of the EC/KBC 60 when the user uses the tablet 10 for the first time, when the user uses the keyboard dock 12 for the first time (when the tablet 10 is docked to the keyboard dock 12 for the first time), and when the recommendation/release message is displayed. Accordingly, even if the battery is used in a production line before shipment and the monitoring timer of the EC/KBC 60 monitors time change in capacity of the battery, the monitoring timer is reset when the user starts to use. It is therefore possible to properly monitor the state of use of the battery of the user, which also makes it possible to properly recommend the eco-charge mode and to automatically switch to the normal charge mode. If the monitoring timer is not reset, when the charge/discharge state of a battery satisfies the condition by using it in the production line, the recommendation message is displayed upon purchase and automatic switching is made to the normal charge mode. Also, if the monitoring timer is not reset when the recommendation/release report message is displayed, the recommendation/release report message is inevitably displayed after the condition is satisfied.

While the recommendation message that prompts the user to switch is displayed in a state of use that recommends the eco-charge mode, switching may be automatically made to the eco-charge mode to display its report message. While switching is automatically made to the normal charge mode to display its report message in a state of use that recommends the normal charge mode, only a recommended message that prompts the user to switch may be displayed.

As described above, according to the embodiment, an appropriate setting screen on the battery charge mode in accordance with the user's state of use can be displayed by checking a state of docking to the keyboard dock and the presence or absence of the battery equipped in the keyboard dock. Also, since the embedded controller of the keyboard dock checks the battery of the keyboard dock, the tablet can recognize the monitoring result of the charge/discharge state of the battery of the keyboard dock at the time of undocking.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic apparatus removably connectable to an external apparatus, comprising:
a first battery; and
circuitry configured to:
set a charge mode of the first battery to a first mode or a second mode, wherein a capacity at a charge completion time of the second mode is smaller than a capacity at a charge completion time of the first mode;
set, when the external apparatus comprises a second battery, a charge mode of the second battery to the first mode or the second mode; and
display
a combination of charge mode options of the first mode and the second mode for the first battery and charge mode options of the first mode and the second mode for the second battery, and
usage information for the electronic apparatus and the external apparatus suitable for the combination.

2. The electronic apparatus of claim 1, further comprising a detector configured to detect a connection state of the electronic apparatus and the external apparatus, wherein
the circuitry is configured to:
display the charge mode options of the first mode and the second mode for the first battery and the charge mode options of the first mode and the second mode for the second battery, when the detector detects that the electronic apparatus is connected to the external apparatus comprising the second battery; and
display the options of the first mode and the second mode for the first battery, when the detector detects that the electronic apparatus is not currently connected to the external apparatus.

3. The electronic apparatus of claim 2, wherein the circuitry is configured to display, when the detector detects that the electronic apparatus was previously connected to the external apparatus and is not currently connected to the external apparatus, the options of the first mode and the second mode for the second battery in a different description from the options when the electronic apparatus is currently connected to the external apparatus.

4. The electronic apparatus of claim 1, further comprising a monitor configured to monitor charging or discharging state of the first battery to obtain a first monitoring result, wherein
the circuitry is configured to display a recommended charge mode for the first battery based on the first monitoring result.

5. The electronic apparatus of claim 4, wherein
the monitor is further configured to monitor, when the external apparatus comprises the second battery, charging or discharging state of the second battery to obtain a second monitoring result, and
the circuitry is further configured to display a recommended charge mode for the second battery based on the second monitoring result.

6. The electronic apparatus of claim 5, wherein
the external apparatus is configured to monitor the charging or discharging state of the second battery, set a first flag when the charging or discharging state of the second battery satisfy a first condition, and set a second flag when the charging or discharging state of the second battery satisfy a second condition, and
the circuitry is further configured to check the first flag and the second flag when the electronic apparatus is connected to the external apparatus.

7. The electronic apparatus of claim 6, wherein
the circuitry is further configured to check the first flag and the second flag when the electronic apparatus changes from a suspend state to a resume state.

8. The electronic apparatus of claim 6, wherein
the monitor is further configured to reset a monitoring result of the charging or discharging state, when the recommended charge mode is displayed, the electronic apparatus is initially activated by a user, or the electronic apparatus is initially connected to the external apparatus.

9. The electronic apparatus of claim 1, wherein
the electronic apparatus comprises a tablet computer and the external apparatus comprises a keyboard dock,
the tablet computer is configured to detect a continuation time of a substantially full charge state of the first battery and the number of times where the first battery discharges from the substantially full charge state to a substantially empty state, and
the circuitry is configured to:
display a message recommending the second mode, when the continuation time of the substantially full charge state of the first battery reaches a first time period; and
display a message recommending the first mode, when the number of times where the first battery discharges from the substantially full charge state to the substantially empty state reaches a first number of times within a third time period.

10. The electronic apparatus of claim 9, wherein
the external apparatus comprises a first keyboard dock comprising the second battery and a second keyboard dock comprising no battery,
the first keyboard dock is configured to detect a continuation time of a substantially full charge state of the second battery and the number of times where the second battery discharges from the substantially full charge state to the substantially empty state, and
the circuitry is configured to:
display a message recommending the second mode, when the continuation time of the substantially full charge state of the second battery reaches a second time period; and
display a message recommending the first mode, when the number of times where the second battery discharges from the substantially full charge state to the substantially empty state reaches a second number of times within a fourth time period.

11. A method for an electronic apparatus removably connectable to an external apparatus and comprising a first battery, the method comprising:
setting a charge mode of the first battery to a first mode or a second mode, wherein a capacity at a charge completion time of the second mode is smaller than a capacity at a charge completion time of the first mode;
setting, when the external apparatus comprises a second battery, a charge mode of the second battery to the first mode or the second mode; and
displaying
a combination of charge mode options of the first mode and the second mode for the first battery and charge mode options of the first mode and the second mode for the second battery, and
usage information for the electronic apparatus and the external apparatus suitable for the combination.

12. The method of claim 11, further comprising:
detecting a connection state of the electronic apparatus and the external apparatus,
displaying the charge mode options of the first mode and the second mode for the first battery and the charge mode options of the first mode and the second mode for the second battery, when it is detected that the electronic apparatus is connected to the external apparatus comprising the second battery; and
displaying the options of the first mode and the second mode for the first battery, when it is detected that the electronic apparatus is not currently connected to the external apparatus.

13. The method of claim 12, further comprising:
displaying, when it is detected that the electronic apparatus was previously connected to the external apparatus and is not currently connected to the external apparatus, the options of the first mode and the second mode for the second battery in a different description from the options when the electronic apparatus is currently connected to the external apparatus.

14. The method of claim 11, further comprising:
monitoring charging or discharging state of the first battery to obtain a first monitoring result;
displaying a recommended charge mode of the first battery base on the first monitoring result.

15. The method of claim 14, further comprising:
monitoring, when the external apparatus comprises the second battery, charging or discharging state of the second battery to obtain a second monitoring result, and
displaying a recommended charge mode for the second battery based on the second monitoring result.

16. The method of claim 15, further comprising:
monitoring, by the external apparatus, the charging and the discharging state of the second battery;
setting a first flag when the charging or discharging state of the second battery satisfies a first condition;
setting a second flag when the charging or discharging state of the second battery satisfy a second condition; and
checking the first flag and the second flag, when the electronic apparatus is connected to the external apparatus.

17. The method of claim 16, further comprising:
checking the first flag and the second flag when the electronic apparatus changes from suspend state to resume state.

18. The method of claim 16, further comprising:
resetting a monitoring result of the charging or discharging state, when the recommended charge mode is displayed, the electronic apparatus is initially activated by a user, or the electronic apparatus is initially connected to the external apparatus.

19. The method of claim 11, wherein
the electronic apparatus comprises a tablet computer and the external apparatus comprises a keyboard dock,
the tablet computer is configured to detect a continuation time of a substantially full charge state of the first battery and the number of times where the first battery discharges from the substantially full charge state to a substantially empty state, the method further comprising:
displaying a message recommending the second mode, when the continuation time of the substantially full charge state of the first battery reaches a first time period; and
displaying a message recommending the first mode, when the number of times where the first battery discharges from the substantially full charge state to the substantially empty state reaches a first number of times within a third time period.

20. The method of claim 19, wherein
the external apparatus comprises a first keyboard dock comprising the second battery and a second keyboard dock comprising no battery,
the first keyboard dock is configured to detect a continuation time of a substantially full charge state of the second battery and the number of times where the second battery discharges from the substantially full charge state to the substantially empty state, the method further comprising:
displaying a message recommending the second mode, when the continuation time of the substantially full charge state of the second battery reaches a second time period; and
displaying a message recommending the first mode, when the number of times where the second battery discharges from the substantially full charge state to the substantially empty state reaches a second number of times within a fourth time period.
